(19) United States
(12) Patent Application Publication
(10) Pub. No.: US 2003/0110103 A1
(43) Pub. Date: Jun. 12, 2003

(54) Cost and usage based configurable alerts

(76) Inventors: Robert Sesek, Meridian, ID (US); Susan M. F. Davis, Nampa, ID (US)

Correspondence Address: HEWLETT-PACKARD COMPANY, Intellectual Property Administration, P.O. Box 272400, Fort Collins, CO, 80527-2400, US

(21) Appl. No.: 10/006,693

(22) Filed: Dec. 10, 2001

(51) Int. Cl. G06F 17/60

(52) U.S. Cl. 705/28

(57) ABSTRACT

A method and apparatus for notification of deviation from predetermined threshold in a system that utilizes consumable and wear components. In one embodiment, a usage rate profile database is configured with one or more thresholds. A controller monitors one or more system parameters and compares them with the database. An alert is generated when deviation beyond the threshold exists. The metrics of the threshold can be quantity, value, or time. The alert action can also be configured to provide simple notification, a description of the deviance, or it can enable a corrective action, such as replenishment of the depletion. In addition, analysis of parameters can occur on a system-wide level, or can be sub-divided by task, user, or budget items.

### BACKGROUND OF THE INVENTION

1. Field of the Invention

The present invention relates to operations management. More specifically, the present invention relates to systems and methods for monitoring supplies and equipment.

2. Description of the Related Art

The operation of many business processes, systems and machines involves the consumption of materials, money, time, and manpower. This often involves an inflow of such consumables, a processing of the consumables in a system or machine, and an output of a product or service. The management of such operations often involves logistical considerations in connection with the coordination of consumables. These considerations typically relate to the passage of time and the flow of cash related thereto. Each consumable has a lead-time for procurement and a rate of consumption, with some variability, that must be managed to keep reserve levels reasonable in view of the cost of maintaining such reserve levels. This must be done in the context of a need to anticipate and prevent down time due to the absence of any single consumable. Another aspect of managing such a system relates to the maintenance of equipment, whether it be routine preventive maintenance or extraordinary maintenance/intervention, as in the case of a break-down. Yet another aspect of management of consumables relates to the control of waste, pilferage and theft.

To lend a more focused view of such business processes, consider a mass-mailing business operation. Paper, ink, toner, (or other marking media), postage, and envelopes are the raw materials that are typically processed in printing, sorting, folding, sealing and mailing operations. Also, business machines are often employed to automate these operations. Such business machines may also require consumables and may incorporate components subject to wear and a finite life expectancy. For example, a postage-metering machine typically has an amount of prepaid postage that is consumed as letters are prepared and mailed. It also consumes ink in the printing of postage on envelopes. Similarly, a laser printer consumes toner as pages are printed, which depletes the useful life of the toner transfer drum, and other components, as the number of printed pages increases. Therefore, if such a system is to operate reliably and efficiently, some form of control and monitoring system should be used.

A fully manual approach to the monitoring of consumables has been used. Actual levels of materials are measured, whether it is in process or in reserve, and an estimate is made as to when replacements should be ordered, and at what level they should be maintained. Limited automated applications have also been employed, such as the use of “gas gauge” sensors in toner and inkjet cartridges operating in laser and inkjet printers. Such a sensor determines when a low level exists, and then activates an alert such as an indicator light on a display panel in the printer. It is also known to communicate these alerts to remote locations, such as over a computer network, to a user console, or even the activation of a remote alert by telecommunications.

Management of the systems also involves planning. Long-term trends can be observed and consumption budgeted so that a reserve inventory is maintained according to the consumption trend. Another aspect of the budgeting of consumables is the correlation thereof with a financial budget in a business entity. Such long term trends and planning are somewhat effective, but they do not adapt well to situations that deviate from the normal trend of consumption. A sharp increase in consumption can lead to a rapid depletion of reserve levels of consumables. Prior techniques for management of consumables are not well adapted to dynamic variances in consumption levels. This also applies to reserve parts that are not consumable, but are necessary for replacement of worn components.

Another aspect of variances in consumption and wear is related to causal relationships. Machines and systems are not perfect and are therefore prone to malfunctions and abuses. For example, a postage meter may be improperly programmed to imprint excessive postage on mailed items. This results in an increase in consumption, which in turn may lead to an unexpected depletion of consumable reserves. Another example is the case where a mailing machine inserts more than one of the same printed item into a single envelope. The result is an increased consumption of paper, toner or ink, and increased wear of other components.

While the prior techniques might detect the reduction of reserves and notify the operator of a need to increase reserves, they tend to fail to correlate this information to the causation of the depletion. The foregoing increases also affect budgetary considerations. If the rate of consumption for postage, paper, or ink exceeds plan, while not satisfying the required output demands, there may come a point in time where actual expenditures exceed budget. This often does not occur until much later than the initial time the malfunction first began, when it is too late to take a corrective action.

Deviation in the rates of consumption and wear are often the result of actions other than malfunctions. For example, there may be theft or pilferage of consumables or of the services a given process is designed to yield. An example is the case where an employee uses postage for personal items. If this occurs, then the amount of consumption increases and the budget planning is affected as well.

All of these variables result in challenges to the management of such machines, processes and systems. Thus, there is a need in the art for a system or method for improving the monitoring of wear and consumables in machines and processes, alerting of operators with respect thereto, and facilitating budget management therefor.

### SUMMARY OF THE INVENTION

The need in the art is addressed by the methods and apparatus taught by the present invention. The present invention teaches a method of generating an alert for notification of a system condition that deviates from a usage rate profile. The method includes the steps of: configuring usage rate profile data in a database and monitoring a parameter of the system, comparing the parameter with the usage rate profile data, and generating an alert condition if the parameter deviates from the usage rate profile data.

In a refinement of this invention, the usage rate profile data includes acceptable consumption rates for system consumable materials. The usage rate profile data can also include wear rate data for various system components. In a further refinement, the monitoring step includes repetitively reading the parameter to determine an actual rate of usage. The parameter can be either a consumable material level indicator or a component wear indicator. In further refinements, the rate profile data is organized by users or by accounts so that consumption can be identified accordingly. The usage rate profile data can include budget expenditure rate data; the budget rate expenditure data may be organized by budget users. Or, the budget expenditure data is organized by budget account. In another area of refinement, the usage rate profile data is organized with various aspects of time. This includes organization by time of day, by day, and by calendar events.

In a further refinement, the configuring step further includes the steps of periodically performing the monitoring step and determining a trend of parameter values over time, and then saving the trend of data values in the usage rate profile data. In a further refinement, the parameter is compared with the trend of data values. In a further refinement, the method adds the steps of receiving reserve level data of a system resource corresponding to the parameter, and calculating a depletion factor with respect to the trend of parameters values and the reserve level data. In a further refinement, the generating step includes the step of outputting the depletion factor. In a further refinement, the method includes the step of allocating the system resource according to a usage priority factor so that higher priority tasks may be assigned to receive system resources before lower priority tasks. In a further refinement, the priority factor is based on user identity. In a further refinement, the usage priority factor is based on account identity. In a further refinement, the alert condition includes an indication of the depletion factor. In a further refinement, the method includes the step of automatically ordering replenishments for the system resource in response to the alert condition. Thus, the depletion calculation is used advantageously to avoid down time due to a lack of resources.

In yet other refinements, the alert condition includes an alert indicator. In a further refinement, the generating step further includes the step of communicating the alert condition via telecommunications, such as but not limited to wire-line or wireless signaling. In a further refinement, the generating step includes the step of disabling the system to prevent waste and misappropriation of resources.

The present invention also teaches a corresponding apparatus for providing an alert notification for a system. The apparatus includes a means for configuring usage rate profile data in a database, a means for monitoring a parameter of the system, a means for comparing the parameter with the usage rate profile data, and a means for generating an alert condition if the parameter deviates from the usage rate profile data. In a refinement of this apparatus, the usage rate profile data includes consumption rates for system consumable materials. The usage rate profile data can include wear rate data for system components. The parameter can be a consumable material level indicator or a component wear indicator. In a further refinement, the usage rate profile data includes budget expenditure rate data, and can be organized by time.

In other refinements of the apparatus, the means for configuring further includes a means for periodically monitoring the parameter, a means for determining a trend of parameter values over time, and a means for saving the trend of data values in the usage rate profile data. In a refinement of this, the parameter is compared with the trend of data values. In a further refinement, the apparatus also includes a means for receiving reserve level data of a system resource corresponding to the parameter, and a means for calculating a depletion factor with respect to the trend of parameters' values and the reserve level data. In a further refinement, the apparatus also includes a means for allocating the system resource according to a usage priority factor. In a further refinement, the apparatus also includes a means for automatically ordering replenishments for the system resource in response to the alert condition. In a further refinement, the apparatus also includes a means for disabling the system.

### BRIEF DESCRIPTION OF THE DRAWINGS

FIG. 1 is a block diagram of an illustrative embodiment of the present invention.

FIG. 2 is a flow diagram of an illustrative embodiment of the present invention.

FIG. 3 is a flow diagram of a second illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

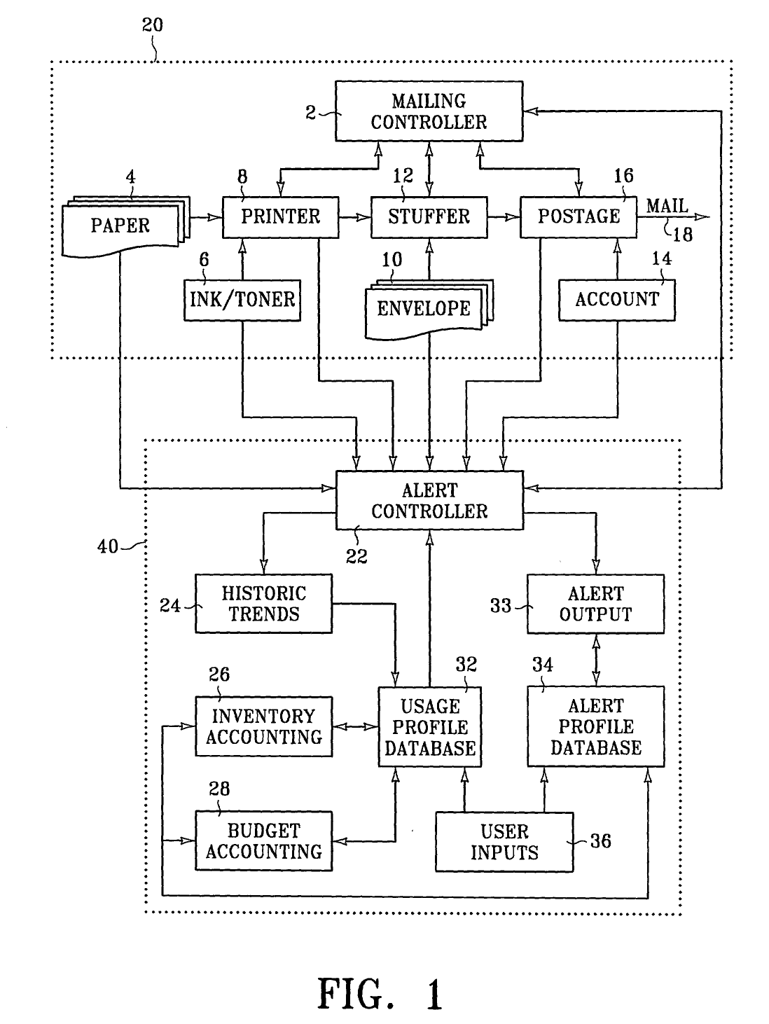

Reference is directed to FIG. 1, which is a functional block diagram of an illustrative embodiment of the present invention. The present invention is readily applicable to any business process, system, machine, or mechanism that involves consumable materials, has components that wear out over time, or consumes financial resources as it operates. Thus, the present invention has very broad application. In the illustrative embodiment, a mass mailing system 20 is used by way of example. Nonetheless, those skilled in the art will appreciate that the present invention is not limited thereto.

A mass mailing system typically includes the printing, stuffing, stamping, sorting and mailing of paper materials. Modern mass mailing operations also incorporate non-paper items into mailings and mailers. Non-paper items include, but are not limited to, compact disks, cards, stickers, product samples and so forth. Thus, the mass mailing system 20 of the illustrative embodiment of FIG. 1 comprises a printer 8 that receives paper from a paper tray 4 and prints text and images using toner or ink from a toner or ink reservoir 6. Whether the printer 8 is a laser printer, an inkjet printer, an offset printer, or any other type of printing device does not matter with respect to the present invention. For the remainder of this discussion, it will be assumed that a laser printer is used, by way of example. Thus, the printer 8 is a machine that requires and uses the consumables of paper and toner. In addition, the printer 8 has internal components (not shown) that wear out over time. These include but are not limited to a transfer drum, roller and belts and other mechanical components.

The output of the printer 8 is printed materials that are delivered to a stuffer 12, which serves the function of folding the printed materials and inserting them into envelopes that are received from an envelope tray 10. The envelopes are a consumable material and the stuffer 12 also has various mechanical components (not shown) that wear over time and use. The stuffed envelopes are delivered to a postage meter 16, which serves the function of weighing the items and applying the appropriate amount of postage to the envelopes. The postage is financially accounted for by debiting an account 14. Postage meters and accounting systems are well known in the art, such as those devices provided by Pitney Bowes for many decades. The output of the mass mailing system is mail 18, which is delivered to a postal carrier in this illustrative embodiment.

The operation and coordination of the various components of the mass mailing system 20 are under the control of a mailing controller 2, which may be a personal computer, for example. As the system operates, the consumable materials are consumed and it is therefore necessary to monitor the levels of such materials so that the system does not operate with one or more of these consumables at empty levels. It is known in the art to utilize level sensors to determine when a consumable is depleted, or near depletion. For example, an “out of paper” sensor can be used in paper tray 4. Similarly, a toner level sensor can be used in the toner reservoir 6, or an envelope level sensor in envelope tray 10. The mailing controller 2 generates an alert to the system operator when a consumable level is low or exhausted so that the consumable can be replenished and the system can continue to function.

As noted herein before, the basic notification that a consumable level is depleted fails to offer optimum notification to the system user. In practice, the system operator has a good understanding of the system operation in normal conditions and plans accordingly. For example, if one thousand mail items are to be produced, the system operator may load five hundred sheets of paper and five hundred envelopes, knowing that half way through the job run he will have to replenish both so that the total one thousand items can be produced. In this situation, the low-level indicator merely notifies the system operator about when the anticipated task of replenishing the consumables must be taken. Similarly, the same one thousand items require postage and, assuming a thirty-four cent rate applies, the postage account 14 must have a minimum of $340 in it to cover the cost of postage for this job.

The prior art does not address a number of problems that may occur. For example, if the printer paper feed tray 4 mechanism fails and retrieves two sheets of paper for each print cycle, the paper supply in paper tray 4 is consumed at twice the anticipated rate. However, the aforementioned low level alert notification will not notify the system operator until the paper supply is depleted, and after the waste has occurred. Similarly, if the postage meter scale 16 is improperly set, the postage rate applied may be too high, perhaps doubled at sixty-eight cents per item. A low postage account notification will not occur until the postal account 14 is depleted. Alternatively, if rates of depletion are too low, this may also be indicative of system problems, but may not be likely noticed until either mail is rejected or returned. In another example, network traffic may slow the data rate for jobs sent to the printer so the user is forced to frequently waste time checking the job to know when replenishment is needed. The present invention improves upon the prior art in that the rate of consumption, usage and cost are considered in the analysis.

Again referring to FIG. 1, the illustrative embodiment cost and usage based configurable alerts apparatus and method 40 are illustrated. An alert controller 22 is coupled to receive inputs from the aforementioned sensors. The following list is not intended to be exhaustive, as there are a great variety of sensing devices that could be employed including: consumable material level sensors, item counting sensors, wear sensors and indicators, optical sensors, acoustic sensors, thermal sensors, motion sensors, speed and velocity sensors, weight sensors, account values for postage meters, cost values for various consumables, etc. The output signals from the sensors are coupled to inputs on alert controller 22. The implementations of such connections are understood by those skilled in the art. The alert controller 22 is capable of reading the sensor signals from time to time (sampling) and to make both absolute sensor readings as well as trend sensor readings and extrapolate (predict) future sensor readings from each sensor. For example, the alert controller 22 can read the paper tray 4 level sensor by merely reading the instantaneous level to determine the amount of paper remaining in the tray 4. In addition, the alert controller 22 can make multiple readings over time to determine the rate of consumption of the paper. The rate may be calculated with respect to time, or with respect to item count. More particularly, the rate may be stated in units of pages per minute, or in pages per item produced. The alert controller is operable to correlate the instantaneous sensor readings and rate information among the various sensor inputs. This is of significant utility since, for example, it allows the alert controller 22 to be programmed to correlate page count to postage weight or paper feed rate to toner consumption rate. As will be more fully discussed hereinafter, this correlation greatly enhances the ability of the present invention to quickly determine when an operation issue arises and to alert the system user early so that corrective action can be implemented before substantial waste occurs.

The illustrative embodiment in FIG. 1 employs a usage profile database 32. This database 32 is configurable with data that defines the reasonable operational bounds of the system, which is integral to the alert apparatus/systems 40. In operation, the alert controller 22 gathers sensor data, both as absolute and as trend data, and compares this data with usage profile data from the database 32. When bounds are exceeded an alert is generated through alert output 33. Usage profiles can be many and varied, depending of the kinds of sensor inputs available, the requirements of the system, and the nature of the process being monitored, as well as the desires of the operator and the way in which the database is configured. Accounting and financial data can also be monitored and implemented in the usage profile database. For example, user configurable alerts based on cost and volumes can be added to the database 32 through the user interface 36. If a particular job was allocated a fixed amount of consumables, or a fixed dollar amount for the process, the database 32 is configured to monitor the consumption for that particular job and generate an alert when the predetermined cost or volume has been reached, or is nearly reached. A system administrator sets the alert levels so as to trigger an alert when those certain events have occurred or the thresholds have been crossed. Thus, each job can be given a fixed dollar amount or bank account, and if the bank balance was below a set limit and projected usage would cause the bank to be depleted before the work was done, an alert would be generated. This serves as notice to discontinue the job to avoid a budget overrun, or a need to increase the budget for the job. This operation prevents a particular user or a particular job from using more than a certain allotment from the bank, which implies that other jobs or users would not have the needed resources available.

As noted earlier, the rate of consumption can be indicative of potential problems in the system operation. Excessive page counts per item, excessive postage, multiple mailings to a given addressee are all kinds of problems that tend to consume resources at a rate greater than planned. The usage profile database 32 is programmed to address these issues. The system rate of consumption is indicative of these issues. If the system operator knows that a media consumption rate of one thousand pages per hour and postage of $340 per hour is the norm, the database can be programmed with a consumption rate consistent with that, plus perhaps 10% for routine variances. As the alert controller 22 gathers data from the various sensors, it calculates the rate of consumption and compares this with the database 32 threshold levels. When one is exceeded, the alert controller 22 generates an alert at alert output 33. Conceptually, there is a predicted rate of consumption plus a variance factor that set a usage rate threshold which is programmed into the database 32. The alert controller 22 monitors sensors to establish the actual rate, which is then compared with the usage profile database 32 rate. A deviance from the acceptable rate of consumption causes an alert to be generated.

The usage profile database is programmed and configured through user inputs 36. This data includes absolute values, rates, times, dates and other factors. With respect to time, the system user can program in certain periods of time and assign usage rates thereto. This is useful, for example, in the case of a system that operates during the normal business day, such as postage processing systems. The limits may be from 8:00 AM to 5:00 PM with a normal rate of consumption. If postage is consumed during off-hours, an alert is generated. This aids in identifying theft and pilferage of consumable resources. This approach can be applied to the overall system process as well. The time can be resolved to hours of the day, days of the week, calendar dates, and so forth. These dates and amounts can also vary by individual user or by various user groups. Consumption rates can be average, minimal, zero or any other reasonable value to account for usage habits and trends.

The usage profile database in FIG. 1 can also be programmed automatically through analyses of historic trends 24. This action is accomplished by monitoring prior usage and consumption patterns by the alert controller 22 and processing this information to determine trends of usage 24. For example, it may be a trend that the system produces one thousand items per day on average with a deviation of plus or minus one hundred items. It may be a trend that the toner reservoir is replenished once per week. It may be a trend that the average envelope is stuffed with 2.5 sheets of paper in any given week, and so forth. These trends are transferred to the database 32 and serve as a reference point for future operation. When reasonable deviations from these trends occur, the alert controller 22 generates an alert 33 indicating the deviation from the historic trends. This serves to notify the system user of the deviation from the trend so that the cause can be determined and corrective action taken if appropriate. Conventional processes of gathering data and calculating trends may be used as will be appreciated by those skilled in the art.

The usage profile database 22 receives sources of input data other than user inputs 36 and historic trends 24. Additional information is received from the budget accounting software 28 and inventory management software 26 related to the system that is being monitored. The budget accounting software allows the database 32 and controller 22 to correlate consumption of consumables and their associated costs to budget plan, both in terms of materials and money. This is accomplished at various levels, including the user and job levels. An alert is generated 33 when budget levels are exceeded. In addition, the rate of consumption is monitored in view of the budget and the time of budget depletion is calculated so that an alert can be generated in advance of the actual depletion.

The usage profile database serves as the focal point for the collection of operational data from the user inputs 36, the historic trends 24, inventory accounting levels and reserves 26, and budget accounting 28. In operation, sensory inputs to the alert controller 22 are used to calculate various consumption, wear and cost data or parameters that are compared with usage profile data. When predetermined thresholds are met or exceeded, an alert condition is generated. This naturally leads to another aspect of the present invention relating to alert generations, alert conditions and alert responses.

As discussed above, the deviation of a parameter from usage profile data generates an alert condition. As noted above, a parameter is a processed output of the alert controller 22 that may be a simple level indication or a more complex determination such as a long-term trend calculation. The usage profile data are also potentially simple or complex. A deviation is a difference, either above or below, of what is actually measured from an input usage profile level. The alert condition is output to alert output 33. The alert output includes an indication of the nature of the deviation event leading to the alert, and this information is used to access an alert profile database 34, which provides the responsive alert action to be taken. This structure adds another level of flexibility for the system operator as it allows the alert action to be tailored to the alert event. The user can input the desired action through user inputs 36, which are coupled to the alert profile database 34. A great variety of alert actions can be programmed into the alert profile database 34. An action such as the illumination of an indicator lamp or icon is a common option. A display can be used, which has the advantage of providing a visual indication of the alert condition, such as an image, text, or icon related to the alert event. The text or image can be recalled from the alert profile database 34, or can be generated locally at the display point. The alert output 33 can be coupled to a remote device or location as well. The message can be routed to a printer so that a hard copy can be produced. For example, an e-mail can be sent to the account of the system user, or other individual. Other means of telecommunications can be employed such as radio links, radio pagers, telephone coupling, and other telecommunications media known to those skilled in the art.

The alert output can also produce controlling outputs. If the output is coupled to the accounting software, the alert can include an estimation of the depletion of a resource, and a recommendation for a replenishment quantity. This can anticipate delivery lead-time, as well. The output can be more than a recommendation, it can also be coupled to the vendor of the material and represent a purchase order, thereby automating the reorder function. In addition, the alert output 33 can be coupled back to the system and disable the system to prevent further operation or waste until a corrective action can be evaluated and, if necessary, be taken.

Another subtle application of the present invention relates to hardware usage profiles. For example, it is understood by those skilled in the printing art that the manner by which hardware is utilized can affect its useful life i.e., its wear rate. In some cases, the effect can be severe with respect to the useful life of the device. One example is the drum wear induced by a large number of consecutive prints of the exact same page versus the lesser wear caused by the page content continually changing. Another example is the scenario where many one page jobs are sent consecutively resulting in many drum rotations and quicker drum wear as opposed to sending the many one page jobs all at the same time as part of a larger job which would not have all of the excess drum rotations since the pages would be moving through the paper path consecutively. The monitoring process taught by the present invention can track this when the usage profile database is programmed to test for this threshold, and a suitable alert can be added to the alert profile database to inform the system user and/or system administrator of the deleterious relationship. In addition, the reduced life expectancy can be factored into the depletion calculations and order notification process. Inkjet printers have similar usage aspects. For example, consider the case where continuous use is preferred over intermittent use to prevent inkjet nozzles from drying. Other utilization and performance relationships that affect component life expectancy will be appreciated by those skilled in the area of art pertinent to the particular systems being adapted to the teachings of the present invention.

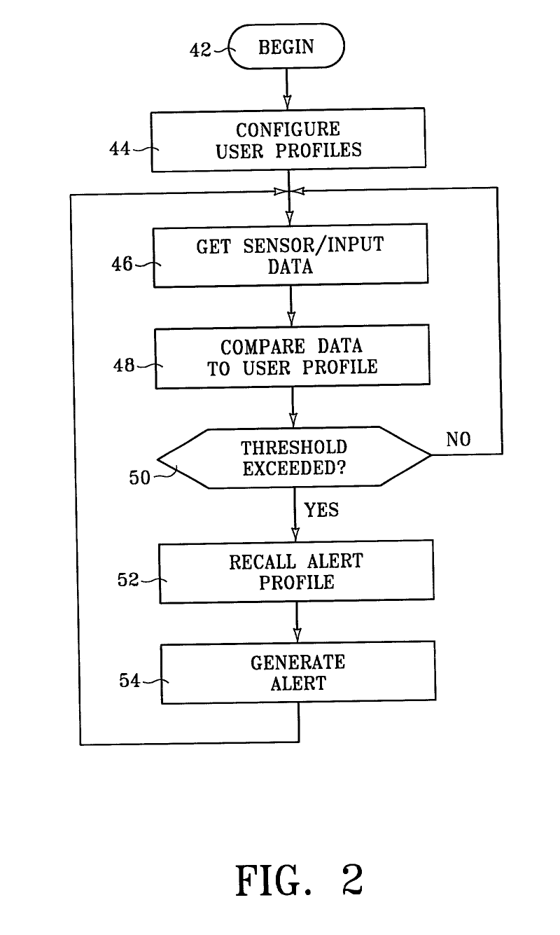

Reference is now directed to FIG. 2, which is a flow diagram of an illustrative embodiment of the present invention. The diagram is structured as a software algorithm, although any process implementation would be equally suitable, that is entered at step 42. The process then proceeds to step 44 where the user profile database is configured. This can be the initial configuration, or a subsequent update to the configuration. It should be understood that the configuration could be accomplished by a system user, or by others. For example, the provider of the alert system may incorporate a default configuration as a means to simplify the initial installation of the system, or to offer performance upgrades from time to time. A third party could also offer a configuration service. Continuing in FIG. 2, at step 46, the alert controller gathers the sensor data at step 46 in a fashion as described herein before. At step 48 the sensor data, which may have been processed to a parameter, is compared with the threshold criteria in the usage profile database. If there is no threshold deviation at step 50, then the process repeats beginning at step 46 and continues in time, waiting for an event that deviates. On the other hand, if at step 50 a parameter deviates from the database thresholds, an alert output is generated and the alert profile recalled at step 52. This leads to the generation of the actual alert at step 54 and a return to the calling routine at step 56.

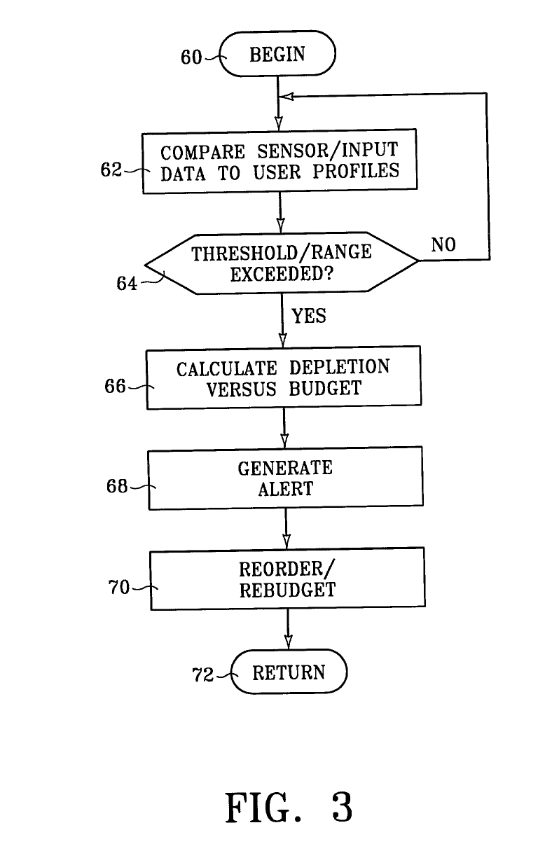

Reference is directed to FIG. 3, which is a flow diagram of an illustrative embodiment of the present invention. In this embodiment, the reordering and re-budgeting functions are illustrated. The process is entered at step 60 and proceeds to step 62 where the sensor data or parameters, are compared with the usage profile database to determine if a deviation has occurred. At step 64, if no deviation has occurred, the flow re-circulates for continuation of the testing cycle. If, on the other hand, a deviation has occurred at step 64, then flow continues to step 66. At step 66, the controller calculates the rate of depletion and compares it versus the available budget of resources. This can refer to either financial resources, as in a monetary budget, or the reserve inventory levels of the particular consumable at issue. At step 68 the alert is generated and correlated to the alert profile database. The resultant information is utilized at step 70 to process the suitable reorder or re-budgeting process. The process returns to the calling subroutine at step 72.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A method of notification for a system, comprising the steps of:
configuring usage rate profile data in a database;
monitoring a parameter of the system;
comparing said parameter with said usage rate profile data; and
generating an alert condition if said parameter deviates from said usage rate profile data.

2. The method of claim 1 wherein said usage rate profile data comprises consumption rates for system consumable materials.

3. The method of claim 1 wherein said usage rate profile data comprises wear rate data for system components.

4. The method of claim 1 wherein said monitoring step comprises repetitively reading said parameter to determine an actual rate of usage.

5. The method of claim 1 wherein said parameter is a consumable material level indicator.

6. The method of claim 1 wherein said parameter is a component wear indicator.

7. The method of claim 1 wherein said rate profile data is organized by users.

8. The method of claim 1 wherein said rate profile data is organized by accounts.

9. The method of claim 1 wherein said usage rate profile data comprises budget expenditure rate data.

10. The method of claim 9 wherein said budget rate expenditure data is organized by budget users.

11. The method of claim 9 wherein said budget expenditure data is organized by budget account.

12. The method of claim 1 wherein said usage rate profile data is organized by time.

13. The method of claim 1 wherein said usage rate profile data is organized by time of day.

14. The method of claim 1 wherein said usage profile data is organized by day.

15. The method of claim 1 wherein said usage profile data is organized by calendar events.

16. The method of claim 1 wherein said configuring step further comprises the steps of:
periodically performing said monitoring step;
determining a trend of parameter values over time; and
saving said trend of data values in said usage rate profile data.

17. The method of claim 16 wherein said parameter is compared with said trend of data values.

18. The method of claim 16 further comprising the steps of:
receiving reserve level data of a system resource corresponding to said parameter and
calculating a depletion factor with respect to said trend of parameters values and said reserve level data.

19. The method of claim 18 wherein said generating step further comprises the step of outputting said depletion factor.

20. The method of claim 18 further comprising the step of allocating said system resource according to a usage priority factor.

21. The method of claim 20 wherein said usage priority factor is based on user identity.

22. The method of claim 20 wherein said usage priority factor is based on account identity.

23. A method of claim 16 wherein said alert condition includes an indication of said depletion factor.

24. The method of claim 23 further comprising the step of automatically ordering replenishments for said system resource in response to said alert condition.

25. The method of claim 1 wherein said alert condition includes an alert indicator.

26. The method of claim 1 wherein said generating step further comprises the step of communicating said alert condition via telecommunications.

27. The method of claim 1 wherein said generating step further comprises the step of disabling the system.

28. An apparatus for providing notification for a system, comprising:
means for configuring usage rate profile data in a database;
means for monitoring a parameter of the system;
means for comparing said parameter with said usage rate profile data; and
means for generating an alert condition if said parameter deviates from said usage rate profile data.

29. The apparatus of claim 28 wherein said usage rate profile data comprises consumption rates for system consumable materials.

30. The apparatus of claim 28 wherein said usage rate profile data comprises wear rate data for system components.

31. The apparatus of claim 28 wherein said parameter is a consumable material level indicator.

32. The apparatus of claim 28 wherein said parameter is a component wear indicator.

33. The apparatus of claim 28 wherein said usage rate profile data comprises budget expenditure rate data.

34. The apparatus of claim 28 wherein said usage rate profile data is organized by time.

35. The apparatus of claim 28 wherein said means for configuring further comprises:
means for periodically monitoring said parameter;
means for determining a trend of parameter values over time; and
means for saving said trend of data values in said usage rate profile data.

36. The apparatus of claim 35 wherein said parameter is compared with said trend of data values.

37. The apparatus of claim 35 further comprising:
means for receiving reserve level data of a system resource corresponding to said parameter and
means for calculating a depletion factor with respect to said trend of parameters values and said reserve level data.

38. The apparatus of claim 37 further comprising a means for allocating said system resource according to a usage priority factor.

39. The apparatus of claim 37 further comprising a means for automatically ordering replenishments for said system resource in response to said alert condition.

40. The apparatus of claim 28 further comprising a means for disabling the system.
